(19) United States
(12) Patent Application Publication
(10) Pub. No.: US 2008/0251977 A1
(43) Pub. Date: Oct. 16, 2008

(54) METHOD FOR MANUFACTURING HONEYCOMB STRUCTURE

(75) Inventors: Kazuya Naruse, Courtenay (FR); Takamitsu Saijo, Dunavarsany (HU); Kazutomo Matsui, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 11/845,975

(22) Filed: Aug. 28, 2007

(30) Foreign Application Priority Data
Sep. 14, 2006 (JP) PCT/JP2006/318299

(51) Int. Cl. C04B 35/64

(52) U.S. Cl. 264/630

(57) ABSTRACT

A method for manufacturing a honeycomb structure includes preparing a material composition containing at least a silicon carbide powder and a binder. The honeycomb structure is manufactured by molding the material composition to form a pillar-shaped honeycomb molded body having a number of cells disposed in parallel with one another in a longitudinal direction with a cell wall therebetween; carrying out a degreasing treatment on the honeycomb molded body; and carrying out a firing treatment on the honeycomb degreased body. The degreasing treatment is carried out at a temperature of about 250 to about 390° C. and under O₂ concentration in the atmosphere of about 5 to about 13% by volume.

### CROSS-REFERENCE TO RELATED APPLICATIONS

The present application claims priority under 35 U.S.C. §119 to PCT/JP2006/318299 filed on Sep. 14, 2006. The contents of this application are incorporated herein by reference in their entirety.

### BACKGROUND OF THE INVENTION

1. Field of the Invention

The present invention relates to a method for manufacturing a honeycomb structure.

2. Discussion of the Background

Particulates such as soot and the like contained in exhaust gases discharged from internal combustion engines of vehicles such as buses and trucks, and construction machines and the like, have become a problem of recent, in which they cause harm to the environment and the human body. To remedy this, there are currently being proposed various kinds of honeycomb filters using a honeycomb structure made from porous ceramics as a filter for capturing particulates contained in exhaust gasses, and thus purifying the exhaust gases. Also, as a honeycomb structure, there has been proposed a honeycomb structure containing silicon carbide due to the excellent high temperature resistance.

Conventionally, upon manufacturing this kind of honeycomb structure, first, a silicon carbide powder, a binder, a dispersant solution, and the like, are mixed to prepare a material composition. Then, this material composition is continuously extrusion molded, and the extruded molded body is cut into a predetermined length to manufacture a rectangular pillar-shaped honeycomb molded body.

Next, the honeycomb molded body manufactured above is dried by using a microwave drying apparatus and/or a hot air drying apparatus, and the predetermined cells are sealed so that either one of the end portions of each of the cells is sealed. After the sealed state has been achieved, degreasing and firing treatments are carried out to manufacture a honeycomb fired body.

After this, a sealing material paste is applied to the side faces of the honeycomb fired body, and a number of honeycomb fired bodies are then bonded together. Then, an aggregated body of the honeycomb fired bodies with a number of honeycomb fired bodies bonded together by interposing a sealing material layer (adhesive layer) is manufactured. A cutting treatment is then carried out on the resulting aggregated body of the honeycomb fired bodies by using a cutting machine and the like, to manufacture a honeycomb block of a predetermined form, such as a round pillar, a cylindroid shape, and the like. Finally, a sealing material paste is applied to the periphery of the honeycomb block to form a sealing material layer (coat layer), thereby completing the manufacturing of a honeycomb structure.

In the method for manufacturing a honeycomb structure, after having manufactured the honeycomb molded body by extrusion-molding, a degreasing treatment is carried out on the molded body. As such degreasing treatments, a method for carrying out a degreasing in an airflow with an oxygen content in the range of 1 to 10%, and a method for carrying out degreasing in an air atmosphere are proposed in Japanese Unexamined Patent Application Publication Nos. 1998-167854 and 2002-097076. The contents of these publications are incorporated herein by reference in their entirety.

### SUMMARY OF THE INVENTION

A method for manufacturing a honeycomb structure of the present invention is a method for manufacturing a honeycomb structure including the steps of: preparing a material composition containing at least a silicon carbide powder and a binder; manufacturing a pillar-shaped honeycomb molded body in which a number of cells are disposed in parallel with one another in a longitudinal direction with a cell wall therebetween by molding the material composition; manufacturing a honeycomb degreased body by carrying out a degreasing treatment on the honeycomb molded body; and manufacturing a honeycomb structure such as a honeycomb fired body by carrying out a firing treatment on the honeycomb degreased body, wherein the degreasing treatment is carried out at a degreasing temperature of about 250 to about 390° C. and under O₂ concentration in the atmosphere of about 5 to about 13% by volume.

In the method for manufacturing a honeycomb structure, a carbon content in the honeycomb degreased body is preferably in the range of about 0.5 to about 2.0% by weight. In addition, in the method for manufacturing a honeycomb structure, a SiO₂ content in the honeycomb degreased body is preferably in the range of about 1.9 to about 3.4% by weight. Also, in the method for manufacturing a honeycomb structure, a weight ratio of Sio₂ and carbon contained in the honeycomb degreased body is preferably over 1.0 and about 5.0 or less.

Also, in the method for manufacturing a honeycomb structure, a content of carbon source material in the material composition is preferably in the range of about 8 to about 18% by weight. In addition, in the method for manufacturing the honeycomb structure, the binder is preferably a compound which is decomposed at about 250 to about 390° C. Also, in the method for manufacturing a honeycomb structure, the compounding amount of the binder is preferably in the range of about 1 to about 10 parts by weight per 100 parts by weight of the silicon carbide powder. Also, in the method for manufacturing a honeycomb structure, the material composition preferably further contains one of a plasticizer and lubricant which are decomposed at temperatures of about 250 to about 390° C.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view schematically illustrating one example of the honeycomb structure;

FIG. 2a is a perspective view schematically illustrating the honeycomb fired body forming the honeycomb structure illustrated in FIG. 1;

FIG. 2b is a cross-sectional view taken along line A-A of FIG. 2a;

FIG. 3 is a graph illustrating the relationship between the degreasing temperature used in Examples 1 to 4 and Comparative Examples 1 and 2, and the average pore diameter and the pressure loss of the honeycomb structures;

FIG. 4 is a graph illustrating the relationship between the degreasing temperature used in Examples 1 to 4 and Comparative Examples 1 and 2, and the bending strength of the honeycomb fired bodies;

FIG. 5 is a graph illustrating the relationship between the O₂ concentration in the atmosphere in the degreasing treatment used in Examples 5 to 8 and Comparative Examples 3 and 4, and the average pore diameter and the pressure loss of the honeycomb structures; and

FIG. 6 is a graph illustrating the relationship between the O₂ concentration in the atmosphere in the degreasing treatment used in Examples 5 to 8 and Comparative Examples 3 and 4, and the bending strength of the honeycomb fired bodies.

### DESCRIPTION OF THE EMBODIMENT

The embodiments will now be described with reference to the accompanying drawings, wherein like reference numerals designate corresponding or identical elements throughout the various drawings.

The method for manufacturing a honeycomb structure according to the embodiments of the present invention is a method for manufacturing a honeycomb structure including the steps of: preparing a material composition containing at least a silicon carbide powder and a binder; manufacturing a pillar-shaped honeycomb molded body in which a number of cells are disposed in parallel with one another in a longitudinal direction with a cell wall therebetween by molding the material composition; manufacturing a honeycomb degreased body by carrying out a degreasing treatment on the honeycomb molded body; and manufacturing a honeycomb structure such as a honeycomb fired body by carrying out a firing treatment on the honeycomb degreased body, wherein the degreasing treatment is carried out at a degreasing temperature of about 250 to about 390° C. and under O₂ concentration in the atmosphere of about 5 to about 13% by volume.

In the method for manufacturing a honeycomb structure according to the embodiments of the present invention, since the degreasing is carried out under the above-mentioned conditions, it is possible to leave behind carbon within the honeycomb degreased body to some extent after degreasing, and therefore, it is possible for the honeycomb degreased body to maintain a predetermined shape, while avoiding generation of pin-holes, cracks, and the like in the resulting honeycomb fired body. Also, the honeycomb degreased body of this kind maintains a high thermal conductivity due to the presence of the carbon, and a sintering of the silicon carbide progresses with certainty during the firing treatment, thereby making it possible to manufacture a honeycomb structure having a low pressure loss and a high strength. Here, in the embodiments of the present invention, the term ‘pillar-shaped’ is not limited to round or rectangular pillar shapes, and the shape of the bottom face can be any shape. Hereinbelow, the method for manufacturing a honeycomb structure according to the embodiments of the present invention will be described in the order of the steps.

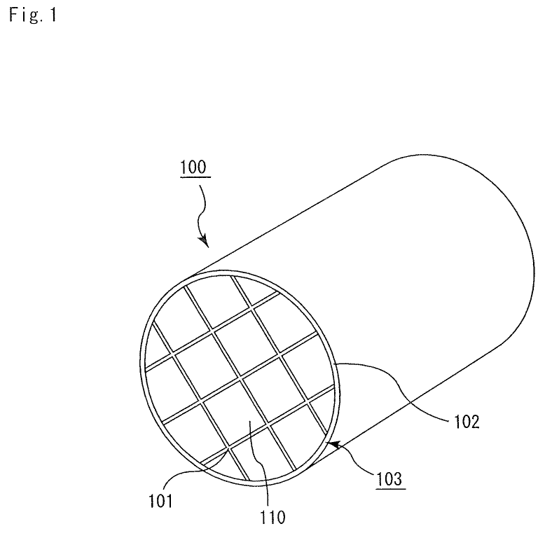

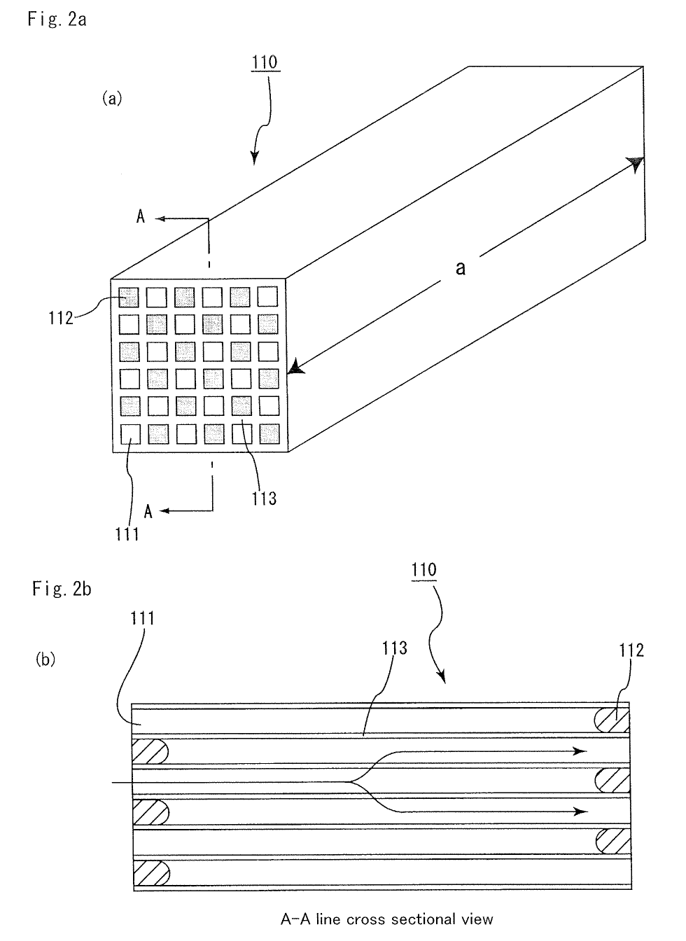

Here, the method for manufacturing a honeycomb structure according to the embodiments of the present invention will be described by taking a case of manufacturing a honeycomb structure as an example where a honeycomb block 103 are formed by a plurality of honeycomb fired bodies 110 bonded together by interposing a sealing material layer (adhesive layer) 101, and then another sealing material layer (coat layer) 102 is formed on the periphery of this honeycomb block 103, as illustrated in FIGS. 1, 1a and 2b. However, the honeycomb structure manufactured by the manufacturing method according to the embodiment of the present invention is not limited to the honeycomb structure of this kind of configuration.

FIG. 1 is a perspective view that schematically illustrates one example of a honeycomb structure. FIG. 2a is a perspective view that schematically illustrates a honeycomb fired body that forms the honeycomb structure, and FIG. 2b is a cross-sectional view taken along line A-A of FIG. 2a.

In a honeycomb structure 100, a plurality of the honeycomb fired bodies 110 of the kind illustrated in FIG. 1 are bonded together by interposing the sealing material layer (adhesive layer) 101 to form the honeycomb block 103, and the sealing material layer (coat layer) 102 is further formed on the periphery of the honeycomb block 103. And as illustrated in FIG. 2a and 2b, in the honeycomb fired body 110, a number of cells 111 are disposed in parallel with one another in a longitudinal direction (the direction shown by an arrow a in FIG. 2a), and cell walls 113 individually separating the cells 111 are allowed to function as a filter.

In other words, the end portion of either the exhaust gas-inlet or the exhaust gas-outlet sides of the cells 111 formed in the honeycomb fired body 110 are sealed by a plug material 112, as illustrated in FIG. 2b. Exhaust gases flowing into one of the cells 111 must pass through the cell walls 113 separating the cells 111 to flow out through another one of the cells 111. When the exhaust gases pass through the cell walls 113, particulates contained within the exhaust gases are captured by the cell walls 113, thereby purifying the exhaust gases.

In the method for manufacturing a honeycomb structure according to the embodiments of the present invention, a material composition containing at least a silicon carbide powder and a binder is prepared. Although the silicon carbide powder is not particularly limited, it is desirable to use the silicon carbide powder which tends not to cause the case where the size of the honeycomb structure manufactured by the following firing treatment becomes smaller than that of the honeycomb degreased body. For example, a silicon carbide powder combining 100 parts by weight of an average particle diameter (D50) in the range of 0.3 to 50 μm, and 5 to 65 parts by weight of a silicon carbide powder of an average particle diameter (D50) in the range of 0.1 to 1.0 μm is desirable. Although it is necessary to adjust the firing temperature in order to adjust the pore diameter or the like of the honeycomb structure, it is possible to carry out the adjustment of the pore diameter by adjusting the particle diameter of the silicon carbide powder. Also, in the present description, the term ‘average particle diameter (D50)’ refers to a median diameter based on volume.

Here, a specific measuring method of a particle diameter is briefly described. A particle size (particle diameter) is typically represented as an abundance ratio distribution per particle diameter by integrating the measuring results. This abundance ratio distribution per particle diameter is referred to as a particle size distribution. As a measuring method of the particle size distribution, for example, a laser diffraction scattering method on a principle of a measurement based on a volume, or the like, can be employed. Here, in such a method, the particle size distribution is measured on the assumption that the particles have a spherical shape. Then, the particle size distribution is converted into a cumulative distribution, and therefore the above-mentioned median diameter (the diameter where an amount of particles included in a group having larger particle diameters and an amount of particles included in a group having smaller particle diameters becomes equal when a group of particles is divided into the two groups by a certain particle diameter) is calculated.

Also, the purity of the silicon carbide powder is preferably in the range of 94 to 99.5% by weight. This is because, if the purity of the silicon carbide powder is within the range, the sintering progresses excellently upon manufacturing a silicon carbide sintered body. In contrast to this, if the purity is less than 94% by weight, there are cases where the progress of the sintering of the silicon carbide is inhibited by impurities, and the purity exceeding 99.5% by weight will result in no further improvements in the sintering properties and no substantial change of the properties such as the strength and the durability or the like of the manufactured honeycomb structure despite the higher cost needed in procuring such a high purity silicon carbide powder.

Here, in the present description, the term ‘purity of a silicon carbide powder’ refers to the % by weight of silicon carbide within a silicon carbide powder. This is because, normally, although termed ‘silicon carbide powder’, impurities (unavoidable impurity) are unavoidably mixed within the powder in manufacturing or storing the silicon carbide powder.

Also, the silicon carbide powder may be an α-type silicon carbide powder, a β-type silicon carbide powder, or a combination of both the α-type and the β-type silicon carbide powder, and the α-type silicon carbide powder is most preferable. This is because the α-type silicon carbide powder is low cost in comparison with the β-type silicon carbide powder, and also in cases where the α-type silicon carbide powder is used, it is easier to control a pore diameter and it is suitable for manufacturing a silicon carbide sintered body having uniform pore diameters.

The binder is preferably a compound that decomposes at a temperature of about 250 to about 390° C. This is because such a compound will be decomposed with certainty in the degreasing treatment. Specific examples of the binder include cellulose class substances such as methyl cellulose, carboxymethyl cellulose, hydroxyethyl cellulose (decomposition temperature: about 350 to about 370° C.); polyethylene glycol (decomposition temperature: about 200 to about 250° C.); and the like. Out of the above, the cellulose class substances are most preferable. This is because since the cellulose class substances have a high water-holding capacity, there are rare cases where water is wrung out of the material composition upon molding. Preferably, the compounding amount of the binder is normally in the range of about 1 to about 10 parts by weight per 100 parts by weight of a silicon carbide powder.

It is also acceptable that the material composition contains a plasticizer, a lubricant and the like. The plasticizer is not particularly limited, and an example includes glycerin and the like. Also, the lubricant is not particularly limited, and examples include polyoxyalkylene series compounds such as polyoxyethylene alkyl ether, polyoxypropylene alkyl ether and the like. Specific examples of the lubricant include polyoxyethylene monobutyl ether, polyoxypropylene monobutyl ether and the like. It is desirable to use plasticizers and lubricants from the above-mentioned substances which are decomposed at temperatures of about 250 to about 390° C._This is because it is possible for the plasticizers and lubricants to become the following carbon source material.

As a specific example of a method for preparing the material composition, it is possible to use a method as follows: preparing a powder mixture by dry-mixing two kinds of silicon carbide powder of different average particle diameters (D50), and a binder; separately preparing a liquid mixture by mixing a plasticizer, a lubricant, water and the like; and then mixing the powder mixture and liquid mixture by using a wet mixer.

It is also acceptable to add a pore-forming agent to the above-mentioned material composition according to need. Examples of the pore-forming agent include balloons that are fine hollow spheres mainly including oxide-based ceramics, spherical acrylic particles, graphite and the like.

Also, the temperature of the material composition prepared here is desirably 28° C. or less. This is because the binder may tend to gel at too high a temperature. In addition, the water content of the material composition is desirably in the range of 8 to 20% by weight.

The content of the carbon source material within the material composition is desirably in the range of 8 to 18% by weight. This is because at the content of carbon source material of less than 8% by weight, the strength of the honeycomb degreased body manufactured through the following degreasing treatment may be insufficient, thereby making it impossible for the honeycomb degreased body to maintain a predetermined honeycomb degreased body shape. This is also because there are cases in which pin-holes, cracks and the like are generated in the honeycomb fired body manufactured in the following firing treatment, and the presence of such pin-holes and cracks causes a reduction in the strength and a variation in the pore diameter. In addition, there are cases in which the pore diameter cannot be enlarged as a result of the content of carbon source material of less than 8% by weight. Alternately, at the content of carbon source material of more than 18% by weight, there are cases in which the content of carbon remaining in the honeycomb degreased body after the completion of the degreasing treatment (hereinafter, also termed ‘the residual carbon content’) becomes too much, thereby inhibiting the sintering of the silicon carbide and generating the variation in pore diameter as a result.

Here, the term ‘carbon source material’ refers to compounds within the material composition which are thermally decomposed during degreasing and thereby able to be left behind as carbon, and specifically refers to a binder, a plasticizer, a lubricant and the like.

Next, this material composition is extrusion molded by an extrusion-molding method and the like. Then, by cutting the molded body manufactured by the extrusion-molding by using a cutting machine, a honeycomb molded body having a shape same as that of the pillar-shaped honeycomb fired body 110 illustrated in FIG. 2a, and not having its end portions sealed, is manufactured.

Next, according to need, a predetermined amount of plug material paste, which will serve as the plug, is filled to one of the end portions of each of the cells, thereby sealing the cells. Specifically, in the case of manufacturing a honeycomb structure functioning as a ceramic filter, either one of the end portions of the each of the cells is sealed. Also, according to need, a drying treatment may be carried out before sealing the honeycomb molded body. In this case, the drying treatment may be carried out by using a microwave drying apparatus, a hot air drying apparatus, a reduced pressure drying apparatus, a dielectric drying machine, a freeze drying apparatus and the like.

Although the plug material paste is not particularly limited, it is preferably a paste having a porosity of a plug being in the range of 30 to 75% formed through the following steps, and for example, it is possible to use the same composition as the material composition.

Filling in of the plug material paste may be carried out according to need, and in the case of having filled in the plug material paste, for example, the honeycomb structure manufactured by the following steps can be suitably used as a ceramic filter, and in the case of not having filled in the plug material paste, for example, the honeycomb structure manufactured by the following steps can be suitably used as a catalyst supporting carrier.

Next, the honeycomb degreased body is manufactured by carrying out a degreasing treatment on the honeycomb molded body. The degreasing treatment is carried out under the following conditions: degreasing temperature about 250 to about 390° C., and O₂ concentration in the atmosphere of about 5 to about 13% by volume. Less than about 250° C. of the degreasing temperature causes an excessive residual carbon content in the honeycomb degreased body, and may result in inhibiting the progress of sintering of the silicon carbide in the following firing treatment and causing occurrences of the variation of the pore diameter and the reduction of the strength in the manufactured honeycomb fired body. Alternately, more than about 390° C. of the degreasing temperature will cause too little residual carbon content in the honeycomb degreased body and sometimes result in failure to maintain a predetermined shape. In addition, since too little residual carbon content may cause a reduction in the thermal conductivity of the honeycomb degreased body, a temperature locally rises in the honeycomb degreased body upon carrying out the firing treatment thereto, giving rise to cracks according to thermal shock. In a case in which such cracks have occurred, the strength of the manufactured honeycomb fired body becomes insufficient.

The degreasing temperature is more desirably in the range of about 250 to about 350° C. This is because, the degreasing temperature in the above-mentioned temperature range makes it possible to manufacture a honeycomb structure having an even higher degree of strength.

O₂ concentration in the atmosphere of less than about 5% by volume makes it difficult to decompose and remove carbon source materials, causes too much residual carbon content in the honeycomb degreased body, and may inhibit the progress of sintering of the silicon carbide in the following firing treatment, resulting in failure to enlarge the pore diameter to design values (the pore diameter expected from an average particle diameter of the silicon carbide powder and a firing condition), non-formation of the neck (the joint site of the silicon carbide particles), and reduction in the strength, in the honeycomb fired body that has passed through the firing treatment. Alternately, O₂ concentration in the atmosphere of more than about 13% by volume diminishes the residual carbon content in the honeycomb degreased body, may cause a reduction in the strength of the honeycomb degreased body and make its shape retention and handling difficult.

In the honeycomb degreased body manufactured by this kind of degreasing treatment, the carbon content within the honeycomb degreased body (residual carbon content) is desirably in the range of about 0.5 to about 2.0% by weight. This is because, with the residual carbon content of less than about 0.5% by weight there are cases in which it is impossible for the honeycomb degreased body to retain a desired shape, and cases in which the strength in the ultimately manufactured honeycomb fired body is insufficient for use. Alternately, a residual carbon content of more than about 2.0% by weight may inhibit the progress of the sintering of the silicon carbide and cause occurrences of the variation in the pore diameter and a larger pressure loss, in the honeycomb fired body.

In order to adjust the residual carbon content within the honeycomb degreased body, the composition of the material composition (the content of carbon source material), as well as degreasing conditions (degreasing temperature, O₂ concentration in the atmosphere), is adjusted, as has been set forth hereinabove.

The SiO₂ content is desirably in the range of about 1.9 to about 3.4% by weight within the honeycomb degreased body. As has already been described hereinabove, one characteristic of the method for manufacturing a honeycomb structure according to the embodiment of the present invention is that it includes a step of manufacturing a honeycomb degreased body containing carbon by carrying out a decreasing treatment under predetermined conditions. Then, manufacturing this kind of carbon-containing honeycomb degreased body makes the embodiment of the present invention useful in the point that the above-mentioned effects can be enjoyed. However, there is a concern that in cases of carrying out a firing treatment on the carbon-containing honeycomb degreased body to manufacture the honeycomb fired body, the following inconveniences may occur.

Specifically, carbon contained within the honeycomb degreased body exhibits excellent effects during the firing treatment; while there is a concern that the inconvenience may occur that the sintering of the silicon carbide may be inhibited because the carbon occupies the positions between silicon carbide powder particles during the firing treatment. Because of this, the carbon contained within the honeycomb degreased body is desirably made to fill its role of improving the thermal conductivity of the honeycomb degreased body during the firing treatment and then made to be ultimately removed from the honeycomb degreased body.

Therefore, in the method for manufacturing a honeycomb structure, the honeycomb degreased body desirably has the SiO₂ content in the range of about 1.9 to about 3.4% by weight in order that the carbon contained within the honeycomb degreased body may be removed during the firing treatment. In a case where the honeycomb degreased body contains SiO₂, a reaction represented by the following reaction formula (1) progresses between the SiO₂ and the carbon to result in the removal of the carbon from within the honeycomb degreased body.

[Formula 1]

SiO₂+C⇄SiO↑+CO↑ (1)

Here, the higher the temperature becomes, the more rightwardly (the side generating CO gas) the reaction represented by the reaction formula (1) progresses. Therefore, early in the firing treatment (rise period of an atmospheric temperature), there is residual carbon present within the honeycomb degreased body, and in comparison with the case where there is no carbon present within the honeycomb degreased body, the honeycomb degreased body exhibits an excellent thermal conductivity in the honeycomb degreased body due to the presence of the carbon. These excellent thermal conductivities prevent a local temperature rise on portions of the honeycomb degreased body, and instead, promote a uniform temperature rise, thereby making it possible to prevent the generation of cracks due to thermal shock. Alternately, when the temperature of the honeycomb degreased body rises to a predetermined temperature, as the reaction represented by the reaction formula (1) progress, the carbon contained within the honeycomb degreased body is converted to CO gas and removed from within the honeycomb degreased body, enabling the sintering of the silicon carbide to progress with certainty.

If the SiO₂ content is less than about 1.9% by weight, the SiO₂ content is too little to readily remove the carbon contained within the honeycomb degreased body, with the result that it becomes difficult for the sintering of the silicon carbide to progress uniformly, and consequently, the variation in the pore diameter of the honeycomb fired body may be caused, and a large pressure loss of the manufactured honeycomb structure may be caused. Alternately, if the SiO₂ content is more than about 3.4% by weight, the sintering of the silicon carbide progresses excessively and causes an excessively large pore diameter, resulting in the reduction of the strength of the honeycomb fired body in some cases.

Here, as methods for adjusting the SiO₂ content within the honeycomb degreased body, it is possible to use methods such as separately adding SiO₂ powder to the material composition, or using a silicon carbide powder that contains a predetermined SiO₂ content as an impurity. Also, it is acceptable to use a method for using a silicon carbide powder that has had its SiO₂ content adjusted by carrying out a purification treatment on a silicon carbide powder containing a large content of SiO₂ impurity. Here, in the purification treatment, SiO₂ is removed by purifying the silicon carbide powder with water solution such as H₂So₄ or NaOH. Also, in the manufacture of the silicon carbide powder, normally, an ingot of a silicon carbide is formed by firing petroleum coke and silica stone in an electric furnace, and a silicon carbide powder having a predetermined particle diameter can be manufactured by pulverizing this ingot. Here, it is possible to adjust the SiO₂ content within the silicon carbide powder by adjusting the length of time of the pulverization. Specifically, the SiO₂ content can be increased by increasing the pulverizing period of time.

Moreover, the weight ratio of the SiO₂ and carbon (SiO₂/C) within the honeycomb degreased body is preferably over 1.0 and about 5.0 or less. The weight ratio of the SiO₂ and carbon (SiO₂/C) of 1.0 or less will sometimes cause the pressure loss on the manufactured honeycomb structure and the variation in the pore diameter. Alternately, the weight ratio of the SiO₂ and carbon of more than about 5.0 will sometimes cause an insufficient strength in the manufactured honeycomb fired body.

Next, by carrying out the firing treatment under predetermined conditions (at 1400 to 2300° C., for example) on the degreased honeycomb molded body, it is possible to manufacture a pillar-shaped honeycomb fired body of a number of cells disposed in parallel with one another in the longitudinal direction with cell walls therebetween, wherein either one of the end portions of each of the cells are sealed.

Next, the sealing material paste, which will serve as the sealing material layer (adhesive layer), is added to the side face of the honeycomb fired body. After this, the step that another honeycomb fired body is piled up on the sealing material paste layer is carried out repeatedly, thereby manufacturing an aggregated body of honeycomb fired bodies of predetermined size.

Examples of the sealing material paste include a paste such as of inorganic fibers and/or inorganic particles, in addition to an inorganic binder and an organic binder, and the like. Examples of the inorganic binder include silica sol, alumina sol and the like. These may be used alone, or in a combination of two or more. Of the inorganic binders, silica sol is most preferable for use.

Examples of the organic binder include polyvinyl alcohol, methyl cellulose, ethyl cellulose, carboxymethyl cellulose and the like. These may be used alone, or in a combination of two or more. Of the organic binders, carboxymethyl cellulose is most preferable for use.

Examples of the inorganic fiber include ceramic fibers such as silica-alumina, mullite, alumina, silica and the like. These may be used alone, or in a combination of two or more. Of the above-mentioned inorganic fibers, an alumina fiber is most preferable for use.

Examples of the inorganic particles include carbide, nitride and the like. Specific examples include an inorganic powder and the like, such as silicon carbide, silicon nitride, boron nitride. These may be used alone, or in a combination of two or more. Of the above-mentioned inorganic particles, silicon carbide, which is superior in thermal conductivity, is most preferable for use.

Furthermore, according to need, a pore-forming agent such as balloons which are micro hollow spheres including oxide-based ceramics, spherical acrylic particles, graphite and the like, may be added to the sealing material paste. The balloons are not particularly limited, and examples include alumina balloons, glass micro balloons, shirasu balloons, fly ash balloons (FA balloons), mullite balloons and the like, for example. Of the above-mentioned balloons, alumina balloons are the most preferable for use.

Next, this aggregated body of honeycomb fired bodies is heated so that the sealing material paste is dried and solidified to form a sealing material layer (adhesive layer). Next, by using a cutting apparatus such as a diamond cutter, and the like, a cutting is carried out on the aggregated body of honeycomb fired bodies, where a plurality of honeycomb fired bodies are bonded together by interposing the sealing material layer (adhesive layer), thereby manufacturing a cylindrical honeycomb block.

Afterward, a sealing material layer (coat layer) is formed on the periphery of the honeycomb block by using the sealing material paste, thereby manufacturing a honeycomb structure having the sealing material layer (coat layer) disposed on the periphery of the cylindrical honeycomb block where a plurality of honeycomb fired bodies are bonded together by interposing the sealing material layer (adhesive layer). Here, the shape of the honeycomb structure manufactured by the method for manufacturing a honeycomb structure of the present invention is not limited to a cylindrical shape, or may be shapes such as a rectangular pillar shape, a cylindroid shape, or any other pillar shapes.

Afterward, according to need, a catalyst is supported to the honeycomb structure. The supporting of the catalyst may be carried out on the honeycomb fired body before manufacturing the aggregate body. In the case of supporting the catalyst, it is preferable to form an alumina film having a high specific surface area on the surface of the honeycomb structure, and applying a co-catalyst and the catalyst such as platinum or the like to the surface of this alumina film.

Examples of methods for forming the alumina film on the surface of the honeycomb structure include a method for impregnating the honeycomb structure with a solution of a metal compound containing aluminium such as Al(NO₃)₃ or the like and then heating, a method for impregnating the honeycomb structure with a solution containing an alumina powder and then heating, and the like.

Examples of a method for applying the co-catalyst to the alumina film include a method for impregnating the honeycomb structure with a solution of a metal compound containing rare earth elements such as Ce(NO₃)₃ and then heating, and the like.

Example of a method for applying the catalyst to the alumina film include a method for impregnating the honeycomb structure with a dinitrodiammine platinum nitric acid solution ([Pt(NH₃)₂(NO₂)₂]HNO₃, platinum content: 4.53% by weight) and the like, and then heating, and the like. It is also acceptable to carry out an application of the catalyst by a method for first applying a catalyst to alumina particles in advance, then impregnating the honeycomb structure with a solution containing an alumina powder where a catalyst is supported, and then heating.

Explanation for the method for manufacturing a honeycomb structure according to the embodiment of the present invention up to this point has been made for the method for manufacturing a honeycomb structure as illustrated in FIGS. 1 and 2a having a structure of a plurality of honeycomb fired bodies bonded together by interposing the sealing material layer (adhesive layer) (also termed ‘aggregated honeycomb structure’); however, the manufacturing method according to the embodiment of the present invention may also be used to manufacture a honeycomb structure having a single honeycomb fired body (also termed ‘integral honeycomb structure’) in place of a honeycomb fired body formed of cylindrical ceramic blocks.

In the case of manufacturing the integral honeycomb structure, first, except that the size of the honeycomb molded body formed by the extrusion-molding is larger in comparison with the case of manufacturing an aggregated honeycomb structure, the honeycomb molded body is manufactured by using the method same as that of the case of manufacturing the aggregated honeycomb structure.

Next, according to need, the drying and/or the filling of the plug material paste into the cells are/is carried out in the same manner as in the manufacturing of the aggregated honeycomb structure. After that, the degreasing treatment is carried out on the honeycomb molded body under the same conditions as in the manufacturing of the aggregated honeycomb structure, thereby manufacturing the honeycomb degreased body. Furthermore, a honeycomb block formed by the honeycomb fired body is manufactured by carrying out the firing treatment on the honeycomb degreased body. Then, according to need, the sealing material layer (coat layer) is formed, thereby finishing manufacturing of the integral honeycomb structure. It is also acceptable to support the catalyst on the integral honeycomb structure as well, with the method described above.

With the method for manufacturing a honeycomb structure according to the embodiment of the present invention, it is possible to manufacture a honeycomb structure having the high strength with the little variation in the pore diameter.

Also, up to this point, the description of the method for manufacturing a honeycomb structure according to the embodiment of the present invention has been set forth by using an example of a honeycomb structure that is able to be used optimally as a ceramic filter. It is also possible to manufacture a honeycomb structure without filling the plug material paste into the cells by using the method for manufacturing a honeycomb structure according to the embodiment of the present invention, and it is also possible to use such an unplugged honeycomb structure optimally as the catalyst supporting carrier.

### EXAMPLES

The present invention is described more specifically by showing Examples below. However, the present invention is not limited to these Examples.

### Example 1

First, 250 kg of an α-type silicon carbide powder (SiO₂ content in powder: 1% by weight) having an average particle diameter of 10 μm, 100 kg of an α-type silicon carbide powder (SiO₂ content in powder: 4% by weight) having an average particle diameter of 0.5 μm, and 20 kg of an organic binder (methyl cellulose/decomposition temperature: 350° C.) were mixed together to prepare a powder mixture. In all Examples and Comparative Examples including the present Example, average particle diameters were measured by a laser diffraction scattering method.

Next, 12 kg of lubricant (UNILUB, manufactured by NOF Corp./decomposition temperature: 230° C.), 5 kg of a plasticizer (glycerin/decomposition temperature: 290° C.), and 65 kg of water were mixed in a separate container to prepare a liquid mixture. Next, by using a wet mixing machine, these powder and liquid mixtures were mixed together to prepare the material composition.

Next, by using conveying equipment, the material composition was conveyed to an extrusion-molding machine, and was then charged into a material charging port. Then, a molded body having a shape same as the shape shown in FIG. 2a, except that the end portions of the cells are not sealed, was manufactured by the extrusion-molding.

Next, after drying the honeycomb molded body by using a microwave and hot-air combination drying apparatus, and next, a plug material paste having a composition same as that of the material composition was filled into predetermined cells. Furthermore, after using the drying apparatus to carry out another drying treatment, degreasing was carried out under the conditions: at a degreasing temperature of 350° C.; an O₂ concentration in the atmosphere of 9%; degreasing period of time for 1.1 hours; to the honeycomb molded body filled with the sealing material paste, thereby manufacturing a honeycomb degreased body. The honeycomb degreased body manufactured in the present step has a carbon content of 0.6% by weight, a SiO₂ content of 2.5% by weight, and a SiO₂ and carbon weight ratio of 4.17, in the honeycomb degreased body.

Moreover, the carbon content within the honeycomb degreased body manufactured in the present step was measured by the combustion method (refer to JIS R 6124). Specifically, after measuring the total weight of the honeycomb degreased body, a 1 g portion of the honeycomb degreased body was excised as a measurement sample. Next, the free carbon within this sample was burned into CO₂ in the midst of oxygen airflow, captured along with oxygen in a burette, and the total gas volume was measured. Next, after absorptive removal of the CO₂, the volume of the residual gas was measured, and the free carbon was quantitatively estimated from the volume reduction amount. Afterward, the carbon content within the honeycomb degreased body was calculated from this quantitative value.

In addition, the SiO₂ content within the honeycomb degreased was measured by the neutralization titration method (refer to JIS R 6124). Specifically, after measuring the total weight of the honeycomb degreased body, a 1 g portion of the honeycomb degreased body was excised as a measurement sample. Hydrofluoric acid (containing potassium fluoride) and hydrochloric acid were added to this sample and then heated, and the free SiO₂ was allowed to precipitate as potassium silicofluoride. This potassium silicofluoride was then dissolved with heated water and titrated with a 0.1 mol/1 (litter) sodium hydroxide solution to quantitatively estimate the SiO₂. Afterward, the carbon content carbon within the honeycomb degreased body was calculated from this quantitative value.

Next, by carrying out a firing at a temperature of 2200° C. in a normal-pressure argon atmosphere for 3 hours, a honeycomb fired body such as a silicon carbide sintered body having a porosity of 40%, a size of 34.3 mm×34.3 mm×150 mm, with a cell count (cell concentration) of 46.5 pcs/cm², and a cell wall thickness of 0.25 mm, was manufactured.

Next, a cylindrical honeycomb block having a 1 mm thick sealing material layer (adhesive layer) was manufactured by bonding a number of honeycomb fired bodies together by using a heat resistant sealing material paste containing 30% by weight of an alumina fiber having an average fiber length of 20 μm, 21% by weight of silicon carbide particles having an average particle diameter of 0.6 μm, 15% by weight of silica sol, 5.6% by weight of carboxymethyl cellulose, and 28.4% by weight of water, then drying at a temperature of 120° C., and next cutting by using a diamond cutter.

Next, a sealing material paste was prepared by mixing and kneading together 23.3% by weight of a silica alumina-fiber (average fiber length of 100 μm, average fiber diameter of 10 μm) as an inorganic fiber, 30.2% by weight of a silicon carbide powder having an average particle diameter of 0.3 μm as inorganic particles, 7% by weight of silica sol (SiO₂ content within the sol: 30% by weight) as an inorganic binder, 0.5% by weight of carboxymethyl cellulose as an organic binder and 39% by weight of water.

Next, by using the sealing material paste, a sealing material paste layer having a thickness of 0.2 mm was formed on the periphery of the honeycomb block. This sealing material paste was then dried at a temperature of 120° C. to manufacture a cylindrical honeycomb structure having 143.8 mm diameter×150 mm length where the sealing material layer (coat layer) was formed on the periphery thereof.

### Examples 2 to 8, Comparative Examples 1 to 4

The honeycomb structure was manufactured in the same manner as in Example 1, aside from the use of the material composition having a composition indicated in Table 1, and the change of the degreasing temperature and the O₂ concentration in the atmosphere to the conditions shown in Table 2, to carry out the degreasing treatment.

TABLE 1

| | Material composition compounding amount (kg) | | | | | | | | |
|---|---|---|---|---|---|---|---|---|---|
| | α-Type silicon carbide powder | | | | | | | | |
| | Average particle | | Average particle | | | | | | |
| | diameter/10 μm | | diameter/0.5 μm | | | | | | Carbon source |
| | | SiO₂ | | SiO₂ | Carbon source material | | | | content within |
| | Total | content | Total | content | Binder | | | | material |
| | powder | within | powder | within | Methyl | Lubricant | Plasticizer | | composition |
| | amount | powder | amount | powder | cellulose | UNILUB | Glycerin | Water | (% by weight) |
| Example 1 | 250 | 1 | 100 | 4 | 20 | 12 | 5 | 65 | 8 |
| Example 2 | 250 | 1 | 100 | 4 | 20 | 12 | 5 | 65 | 8 |
| Example 3 | 250 | 1 | 100 | 4 | 20 | 12 | 5 | 65 | 8 |
| Example 4 | 250 | 1 | 100 | 4 | 20 | 12 | 5 | 65 | 8 |
| Example 5 | 250 | 1 | 100 | 4 | 20 | 12 | 5 | 65 | 8 |
| Example 6 | 250 | 1 | 100 | 4 | 20 | 12 | 5 | 65 | 8 |
| Example 7 | 250 | 1 | 100 | 4 | 20 | 12 | 5 | 65 | 8 |
| Example 8 | 250 | 1 | 100 | 4 | 20 | 12 | 5 | 65 | 8 |
| Comparative | 250 | 1 | 100 | 4 | 20 | 12 | 5 | 65 | 8 |
| Example 1 | | | | | | | | | |
| Comparative | 250 | 1 | 100 | 4 | 20 | 12 | 5 | 65 | 8 |
| Example 2 | | | | | | | | | |
| Comparative | 250 | 1 | 100 | 4 | 20 | 12 | 5 | 65 | 8 |
| Example 3 | | | | | | | | | |
| Comparative | 250 | 1 | 100 | 4 | 20 | 12 | 5 | 65 | 8 |
| Example 4 | | | | | | | | | |

TABLE 2

| | Degreasing condition | | | Carbon content | SiO₂ content | Weight ratio of SiO₂ |
|---|---|---|---|---|---|---|
| | | O₂ | | within | within | and carbon within |
| | Temp. | concentration | Time | degreased body | degreased body | degreased body |
| | ° C. | (% by volume) | (hr) | (% by weight) | (% by weight) | (SiO₂/C) |
| Example 1 | 350 | 9 | 1.1 | 0.6 | 2.5 | 4.17 |
| Example 2 | 250 | 9 | 1.1 | 2.3 | 2.3 | 1.00 |
| Example 3 | 300 | 9 | 1.1 | 1.1 | 2.2 | 2.00 |
| Example 4 | 390 | 9 | 1.1 | 0.5 | 2.5 | 5.00 |
| Example 5 | 350 | 5 | 1.1 | 1.9 | 2.0 | 1.05 |
| Example 6 | 350 | 7 | 1.1 | 1.1 | 2.3 | 2.09 |
| Example 7 | 350 | 11 | 1.1 | 0.7 | 2.7 | 3.86 |
| Example 8 | 350 | 13 | 1.1 | 0.8 | 3.4 | 4.25 |
| Comparative | 230 | 9 | 1.1 | 2.2 | 1.7 | 0.77 |
| Example 1 | | | | | | |
| Comparative | 420 | 9 | 1.1 | 0.4 | 3.5 | 8.75 |
| Example 2 | | | | | | |
| Comparative | 350 | 4 | 1.1 | 3.0 | 1.0 | 0.33 |
| Example 3 | | | | | | |
| Comparative | 350 | 14 | 1.1 | 0.4 | 4.0 | 10.0 |
| Example 4 | | | | | | |

### Examples 9 to 26

The honeycomb structure was manufactured in the same manner as in Example 1, aside from the change of the material blending quantity and degreasing conditions so as to obtain the values shown in Tables 3 and 4 with respect to the content of carbon source material within the material composition, the carbon content and the SiO₂ content within the honeycomb degreased body.

TABLE 3

| | Material composition compounding amount (kg) | | | | | | | | |
|---|---|---|---|---|---|---|---|---|---|
| | α-Type silicon carbide powder | | | | | | | | |
| | Average particle | | Average particle | | | | | | |
| | diameter/10 μm | | diameter/0.5 μm | | | | | | Carbon source |
| | | SiO₂ | | SiO₂ | Carbon source material | | | | content within |
| | Total | content | Total | content | Binder | | | | material |
| | powder | within | powder | within | Methyl | Lubricant | Plasticizer | | composition |
| | amount | powder | amount | powder | cellulose | UNILUB | Glycerin | Water | (% by weight) |
| Example 1 | 250 | 1 | 100 | 4 | 20 | 12 | 5 | 65 | 8 |
| Example 9 | 250 | 1 | 100 | 4 | 15 | 12 | 5 | 65 | 7 |
| Example 10 | 250 | 1 | 100 | 4 | 30 | 12 | 5 | 65 | 10 |
| Example 11 | 250 | 1 | 100 | 4 | 55 | 12 | 5 | 65 | 15 |
| Example 12 | 250 | 1 | 100 | 4 | 75 | 12 | 5 | 65 | 18 |
| Example 13 | 250 | 1 | 100 | 4 | 25 | 12 | 5 | 65 | 9 |
| Example 14 | 250 | 1 | 100 | 4 | 40 | 12 | 5 | 65 | 12 |
| Example 15 | 250 | 1 | 100 | 4 | 10 | 12 | 5 | 65 | 6 |
| Example 16 | 250 | 1 | 100 | 4 | 30 | 12 | 5 | 65 | 10 |
| Example 17 | 250 | 1 | 100 | 4 | 45 | 12 | 5 | 65 | 13 |
| Example 18 | 250 | 1 | 100 | 4 | 75 | 12 | 5 | 65 | 18 |
| Example 19 | 250 | 1 | 100 | 4 | 40 | 12 | 5 | 65 | 12 |
| Example 20 | 250 | 1 | 100 | 4 | 55 | 12 | 5 | 65 | 15 |
| Example 21 | 250 | 1 | 100 | 4 | 75 | 12 | 5 | 65 | 18 |
| Example 22 | 250 | 1 | 100 | 4 | 40 | 12 | 5 | 65 | 12 |
| Example 23 | 250 | 1 | 100 | 4 | 75 | 12 | 5 | 65 | 18 |
| Example 24 | 250 | 1 | 100 | 4 | 100 | 12 | 5 | 65 | 20 |
| Example 25 | 250 | 1 | 100 | 4 | 75 | 12 | 5 | 65 | 18 |
| Example 26 | 250 | 1 | 100 | 4 | 100 | 12 | 5 | 65 | 22 |

TABLE 4

| | Degreasing condition | | | Carbon content | SiO₂ content | Weight ratio of SiO₂ |
|---|---|---|---|---|---|---|
| | | O₂ | | within | within | and carbon within |
| | Temp. | concentration | Time | degreased body | degreased body | degreased body |
| | ° C. | (% by volume) | (hr) | (% by weight) | (% by weight) | (SiO₂/C) |
| Example 1 | 350 | 9 | 1.1 | 0.6 | 2.5 | 4.17 |
| Example 9 | 350 | 9 | 1.1 | 0.4 | 2.7 | 6.75 |
| Example 10 | 350 | 9 | 1.1 | 0.5 | 2.4 | 4.80 |
| Example 11 | 350 | 9 | 1.1 | 0.7 | 2.2 | 3.14 |
| Example 12 | 350 | 9 | 1.1 | 0.85 | 1.9 | 2.24 |
| Example 13 | 250 | 11 | 1.1 | 0.4 | 2.2 | 5.50 |
| Example 14 | 300 | 11 | 1.1 | 0.4 | 3.0 | 7.50 |
| Example 15 | 300 | 7 | 1.1 | 1.0 | 1.0 | 1.00 |
| Example 16 | 300 | 11 | 1.1 | 1.0 | 2.2 | 2.20 |
| Example 17 | 300 | 13 | 1.1 | 1.0 | 3.0 | 3.00 |
| Example 18 | 390 | 13 | 1.1 | 1.0 | 3.5 | 3.50 |
| Example 19 | 250 | 11 | 1.1 | 1.5 | 2.2 | 1.47 |
| Example 20 | 300 | 11 | 1.1 | 1.5 | 3.0 | 2.00 |
| Example 21 | 300 | 13 | 1.1 | 1.5 | 3.5 | 2.33 |
| Example 22 | 300 | 9 | 1.1 | 2.0 | 2.2 | 1.10 |
| Example 23 | 300 | 11 | 1.1 | 2.0 | 3.0 | 1.50 |
| Example 24 | 390 | 13 | 1.1 | 2.0 | 3.5 | 1.75 |
| Example 25 | 300 | 11 | 1.1 | 2.2 | 2.2 | 1.00 |
| Example 26 | 390 | 13 | 1.1 | 2.2 | 3.5 | 1.59 |

After manufacturing the honeycomb fired bodies in Examples and Comparative Examples, a three-point bending strength test was carried out on 10 honeycomb fired bodies. The results are shown in Table 5.

Specifically, in light of JIS R 1601, the three-point bending strength test was carried out by using Instron 5582 at a span distance of 135 mm and a speed of 1 mm/min to measure a bending strength (MPa) of each of the honeycomb fired bodies.

Also, after manufacturing the honeycomb fired bodies in Examples and Comparative Examples, the pore diameters formed in the honeycomb fired bodies were measured by the following method. The results are shown in Table 5.

Specifically, in compliance with JIS R 1655, by using a fine-pore distribution measuring device (AUTOPORE III 9405, manufactured by Shimadzu Corp.) using a mercury injection method, 1 cm cubic portions were cut from the central portions of each of the 10 honeycomb fired bodies as samples, and the fine-pore distributions of the 10 samples were measured with the mercury injection method in a fine-pore diameter range of 0.2 to 500 μm. The resulting average fine-pore diameter was calculated as (4V/A), thereby calculating the average fine-pore diameter and the standard deviation thereof.

Also, a pressure loss of the honeycomb structures manufactured in Examples and Comparative Examples were measured. The results are shown in Table 5. Here, 10 samples were used. As the pressure loss of each of the honeycomb structures, the respective initial pressure loss under a flow rate of 1000 N·m³/h was measured.

TABLE 5

| | Average pore diameter | | | |
|---|---|---|---|---|
| | | Standard | | Honeycomb |
| | Average | deviation | Bend strength | structure pressure |
| | value (μm) | (μm) | (MPa) | loss (kPa) |
| Example 1 | 11.4 | 0.30 | 33 | 8.94 |
| Example 2 | 8.1 | 0.61 | 30 | 9.22 |
| Example 3 | 10.0 | 0.43 | 34 | 9.10 |
| Example 4 | 11.3 | 0.31 | 26 | 8.90 |
| Example 5 | 9.5 | 0.48 | 28 | 9.10 |
| Example 6 | 10.6 | 0.38 | 32 | 9.02 |
| Example 7 | 11.2 | 0.33 | 32 | 8.90 |
| Example 8 | 11.1 | 0.34 | 31 | 8.74 |
| Example 9 | 12.0 | 0.25 | 23 | 9.02 |
| Example 10 | 10.8 | 0.38 | 32 | 9.10 |
| Example 11 | 9.9 | 0.45 | 29 | 9.14 |
| Example 12 | 8.2 | 0.50 | 26 | 9.45 |
| Example 13 | 10.9 | 0.34 | 24 | 8.94 |
| Example 14 | 11.7 | 0.26 | 23 | 8.86 |
| Example 15 | 6.5 | 0.78 | 25 | 9.69 |
| Example 16 | 9.8 | 0.46 | 33 | 9.14 |
| Example 17 | 11.5 | 0.30 | 34 | 8.90 |
| Example 18 | 12.2 | 0.23 | 25 | 8.74 |
| Example 19 | 9.3 | 0.50 | 32 | 9.34 |
| Example 20 | 11.4 | 0.31 | 29 | 8.94 |
| Example 21 | 12.1 | 0.27 | 26 | 8.74 |
| Example 22 | 8.2 | 0.48 | 31 | 9.47 |
| Example 23 | 10.5 | 0.40 | 32 | 9.02 |
| Example 24 | 11.4 | 0.51 | 28 | 8.90 |
| Example 25 | 8.2 | 0.62 | 30 | 9.81 |
| Example 26 | 11.3 | 0.52 | 28 | 8.94 |
| Comparative | 5.7 | 0.86 | 19 | 10.13 |
| Example 1 | | | | |
| Comparative | 12.9 | 0.16 | 17 | 8.90 |
| Example 2 | | | | |
| Comparative | 4.5 | 0.98 | 17 | 10.32 |
| Example 3 | | | | |
| Comparative | 13.4 | 0.10 | 15 | 8.43 |
| Example 4 | | | | |

From the results of Examples 1 to 4 and Comparative Examples 1 and 2, it can be clearly seen that the degreasing temperature used in the method for manufacturing a honeycomb structure is desirably in the range of 250 to 390° C.

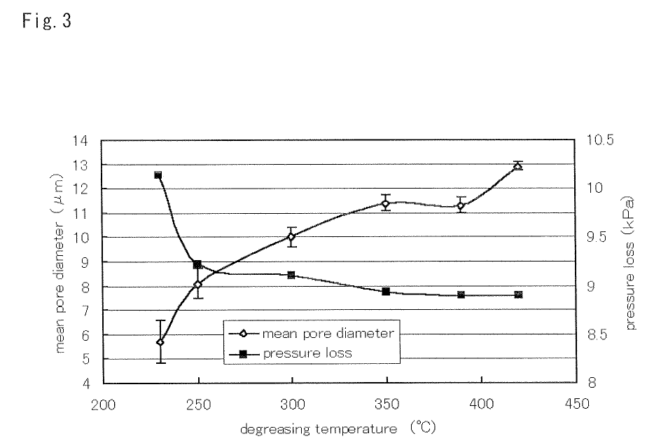

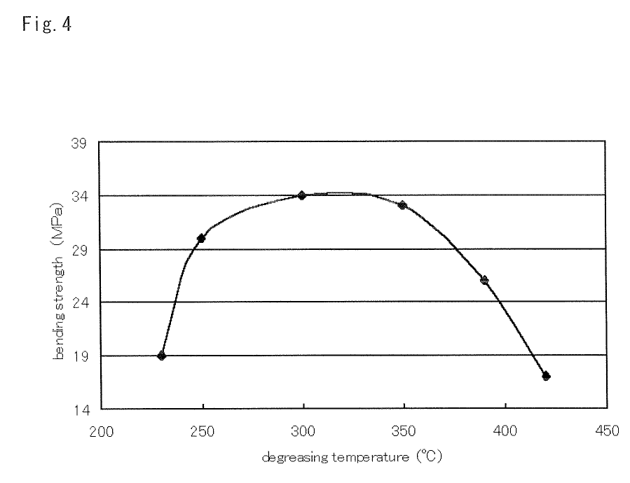

FIG. 3 is a graph illustrating the relationship between the degreasing temperature used in Examples 1 to 4 and Comparative Examples 1 and 2, and the average pore diameter and the pressure loss of the honeycomb structures. FIG. 4 is a graph illustrating the relationship between the degreasing temperature used in Examples 1 to 4 and Comparative Examples 1 and 2, and the bending strength of the honeycomb fired bodies.

By setting the degreasing temperature in the range of 250 to 390° C. in the method for manufacturing a honeycomb structure, it is possible to manufacture a honeycomb structure with a low pressure loss, and having a honeycomb fired body with a sufficient bending strength (25 MPa or more). In contrast to this, it has become clear that if the degreasing temperature is less than 250° C., large variation of pore diameter of the honeycomb structure (honeycomb fired body) occurs, and also the bending strength thereof becomes too low (less than 20 MPa). Alternately, it has also become clear (refer to Table 5, FIGS. 3 and 4) that if the degreasing temperature is more than 390° C., bending strength becomes too low (less than 20 MPa). Also, it has become clear (refer to Table 5, FIG. 4) that by setting the degreasing temperature in the range of 250 to 350° C. in particular, it is possible to manufacture a honeycomb structure having a honeycomb fired body of a high bending strength of 30 MPa or more.

Here, with regard to the honeycomb fired body (size: 34.3 mm×34.3 mm×150.5 mm, cell concentration: 46.5 pcs/cm², and a cell wall thickness: 0.25 mm) manufactured according to the examples, as long as the bending strength is 23 MPa or more, its strength is presumably at a tolerable level as a product; with a bending strength of 25 MPa or more, it is presumably at a sufficient level for use as a product; and with a bending strength of 30 MPa or more, it is presumably an extremely high quality product.

Also, it has become clear that according to the results of Examples 5 to 8 and Comparative Examples 3 and 4 that the O₂ concentration in the atmosphere in the degreasing treatment used in the method for manufacturing a honeycomb structure is preferably in the range of 5 to 13% by volume.

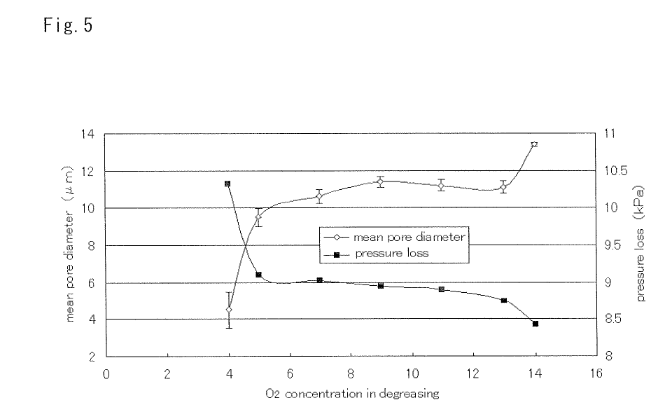

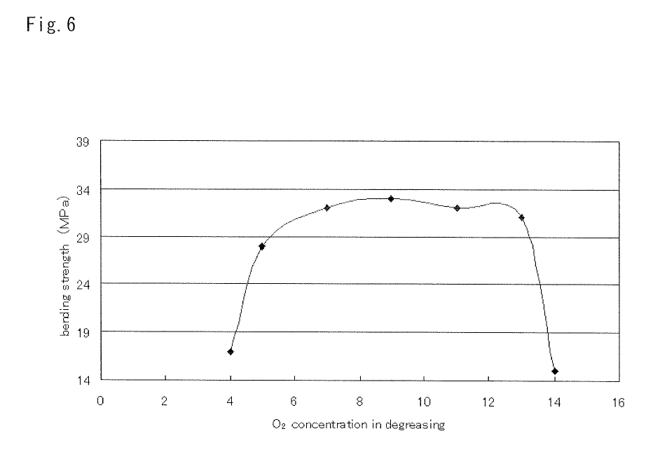

FIG. 5 is a graph illustrating the relationship between the O₂ concentration in the atmosphere in the degreasing treatment used in Examples 5 to 8 and Comparative Examples 3 and 4, and the average pore diameter and the pressure loss of the honeycomb structures. FIG. 6 is a graph illustrating the relationship between the O₂ concentration in the atmosphere in the degreasing treatment used in Examples 5 to 8 and Comparative Examples 3, 4, and the bending strength of the honeycomb fired bodies.

It has also become clear that in the method for manufacturing a honeycomb structure, by setting the O₂ concentration in the atmosphere in the degreasing treatment in the range of 5 to 13% by volume, it is possible to manufacture a honeycomb structure having pores of a uniform diameter, a low pressure loss, and a honeycomb fired body having a high degree of bending strength. In contrast to this, it has become clear that with the O₂ concentration in the atmosphere of less than 5% by volume, it is unlikely to enlarge the pore diameter of the honeycomb fired body, the bending strength of the honeycomb fired body becomes too low (less than 20 MPa), and that if the O₂ concentration in the atmosphere exceeds 13% by volume, the bending strength of the honeycomb fired body becomes too low (less than 20 MPa) (refer to Table 5, FIGS. 5 and 6).

Also, it has become clear in the method for manufacturing a honeycomb structure that a content of carbon source material within the material composition is preferably in the range of 8 to 18% by weight. The content of carbon source material within this range (refer to Examples 1, 10 to 12) makes it possible to manufacture a honeycomb structure having a low pressure loss and a high degree of bending strength. In contrast to this, with the content of carbon source material of less than 8% by weight, there are cases in which the bending strength will be insufficient(refer to Example 9) and variation occurs in pore diameter(refer to Example 15). If the content of carbon source material exceeds 18% by weight, there tends to be a variation in the pore diameter (refer to Examples 24 and 26).

Also, it has become clear that in the method for manufacturing a honeycomb structure, the carbon content within the honeycomb degreased body is preferably in the range of 0.5 to 2.0% by weight, the SiO₂ content within the honeycomb degreased body is preferably in the range of 1.9 to 3.4% by weight, and furthermore, the weight ratio of SiO₂ and carbon within the honeycomb degreased body is preferably over 1.0 and 5.0 or less in the method for manufacturing a honeycomb structure.

The carbon content and the SiO₂ content in the degreased body within the above-mentioned range makes it possible to manufacture a honeycomb structure having pores of a uniform diameter, a low pressure loss, and a honeycomb fired body having a high degree of bending strength (refer to Examples 16, 17, 19, 20, 22 and 23).

Alternately, if the carbon content within the honeycomb degreased body is less than 0.5% by weight, there are cases where the bending strength of the honeycomb fired body is more likely to become low (refer to Examples 13 and 14), and if the carbon content is more than 2.0% by weight, there are cases where large variation occurs in pore diameter, and a pressure loss becomes large (refer to Examples 25 and 26).

Also, it has become clear that if the SiO₂ content within the honeycomb degreased body is less than 1.9% by weight, there are cases where large variation occurs in pore diameter and a pressure loss of the honeycomb structure becomes large (refer to Example 15), and if the SiO₂ content within the honeycomb degreased body is more than 3.4% by weight, there are cases where pore diameter becomes large, and bending strength becomes low (refer to Examples 18 and 21). Here, as seen in Examples 24 and 26, even if the SiO₂ content within the honeycomb degreased body exceeds 3.4% by weight, this does not necessarily mean that the strength will also become low.

Also, at a weight ratio of SiO₂ and carbon within the honeycomb degreased body of 1.0 or less, a pressure loss tends to become great, and large variation tends to occur in pore diameter (refer to Examples 15 and 25). And alternately, at weight ratio of SiO₂ and carbon within the honeycomb degreased body of more than 5.0, there is a trend of bending strength becoming small (refer to Examples 13 and 14).

The contents of JIS R 6124, JIS R 1601, and JIS R 1655 are incorporated herein by reference in their entirety.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A method for manufacturing a honeycomb structure, comprising the steps of:
preparing a material composition containing at least a silicon carbide powder and a binder;
manufacturing a pillar-shaped honeycomb molded body in which a number of cells are disposed in parallel with one another in a longitudinal direction with a cell wall therebetween by molding said material composition;
manufacturing a honeycomb degreased body by carrying out a degreasing treatment on said honeycomb molded body; and
manufacturing a honeycomb structure comprising a honeycomb fired body by carrying out a firing treatment on said honeycomb degreased body,
wherein said degreasing treatment is carried out at a degreasing temperature of about 250 to about 390° C. and under O₂ concentration in the atmosphere of about 5 to about 13% by volume.

2. The method for manufacturing a honeycomb structure according to claim 1, wherein a carbon content in said honeycomb degreased body is in the range of about 0.5 to about 2.0% by weight.

3. The method for manufacturing a honeycomb structure according to claim 1, wherein a SiO₂ content in said honeycomb degreased body is in the range of about 1.9 to about 3.4% by weight.

4. The method for manufacturing a honeycomb structure according to claim 1, wherein a weight ratio of SiO₂ and carbon contained in said honeycomb degreased body is over 1.0 and about 5.0 or less.

5. The method for manufacturing a honeycomb structure according to claim 1, wherein a content of carbon source material in said material composition is in the range of about 8 to about 18% by weight.

6. The method for manufacturing a honeycomb structure according to claim 1, wherein said binder is a compound which is decomposed at about 250 to about 390° C.

7. The method for manufacturing a honeycomb structure according to claim 1, wherein the compounding amount of the binder is in the range of about 1 to about 10 parts by weight per 100 parts by weight of the silicon carbide powder.

8. The method for manufacturing a honeycomb structure according to claim 1, wherein the material composition further contains one of a plasticizer and lubricant which are decomposed at temperatures of about 250 to about 390° C.
